(19) United States
(12) Patent Application Publication
(10) Pub. No.: US 2014/0250116 A1
(43) Pub. Date: Sep. 4, 2014

(54) IDENTIFYING TIME SENSITIVE AMBIGUOUS QUERIES

(71) Applicant: YAHOO! INC., Sunnyvale, CA (US)

(72) Inventors: Kuo-Hsien Hsu, Taipei (TW); Fang-Fei Kuo, Taipei (TW)

(73) Assignee: YAHOO! INC., SUNNYVALE, CA (US)

(21) Appl. No.: 13/782,653

(22) Filed: Mar. 1, 2013

(51) Int. Cl. G06F 17/30

(52) U.S. Cl. CPC G06F 17/30554
USPC 707/728

(57) ABSTRACT

A system and method for generating search results includes: receiving a search query with a search term; parsing the search term; determining that at least a portion of the parsed search term is an ambiguous, time-sensitive query; retrieving an intended search term according to a current time of day from a data store when it is determined that at least a portion of the parsed search term is an ambiguous, time-sensitive query; and preparing a search results page such that search results more closely matching the derived intended search term are placed in a most prominent position on the search results page.

### CROSS-REFERENCE TO RELATED APPLICATIONS

None.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of Web search, and more particularly relates to the field of query processing.

### BACKGROUND OF THE INVENTION

In web search, query terms are often ambiguous and so do not return the results that the user expects. An ambiguous query has more than one interpretation or covers a variety of subtopics. One query may contain two or more different intents. Examples of ambiguous queries are “Apple,” “Java,” and “Jordan.” Consider, for example, the query “Apple” may refer to information about Apple Computer or the fruit. Without knowledge of the user's search context to disambiguate the user intent, a search engine has to diversify the search results to accommodate ambiguous queries.

A simple approach for a web search engine is to allocate the number of results for the top-k results proportionately according to the distribution of user intents. However, this simple approach may perform poorly. Research on result diversification aims to diversify the search results such that the satisfaction of the population of users is maximized. For most approaches to result diversification, one of the most important cues is the user intent distribution for determining the relative importance of each interpretation or subtopic.

Some queries are ambiguous because they are time-sensitive. Search engines attempt to apply a temporal filter to these ambiguous queries. For example, a search for “Olympics” conducted today in the year 2012 is likely to return results for the “2012 Summer Olympics” in the top slots. This is because the search engine will infer that the user's intent is to search for the most current Olympics. Some queries are ambiguous because they may involve multiple intents. For example, a search term of “earthquake” is ambiguous because it can spawn results for multiple earthquake events. Search engines will attempt to disambiguate this query by applying a temporal filter which will likely return the majority of results for the most recent earthquake—“Japan earthquake” rather than “Haiti earthquake.”

There is a need for a system and method to handle queries which are both ambiguous in intent and time-sensitive.

### SUMMARY OF THE INVENTION

Briefly, according to an embodiment of the disclosure, a method for generating search results includes steps or acts of: for generating search results includes: receiving a search query with a search term; parsing the search term; determining that at least a portion of the parsed search term is an ambiguous, time-sensitive query; retrieving an intended search term according to a current time of day from a data store when it is determined that at least a portion of the parsed search term is an ambiguous, time-sensitive query; and preparing a search results page such that search results more closely matching the derived intended search term are placed in a most prominent position on the search results page.

According to another embodiment of the present disclosure, a system for generating search results includes: a memory with computer-executable instructions; and a processor device operably coupled with the memory. The computer-executable instructions include: receiving a search query with a search term; parsing the search term; determining that at least a portion of the parsed search term is an ambiguous, time-sensitive query; retrieving an intended search term according to a current time of day from a data store when it is determined that at least a portion of the parsed search term is an ambiguous, time-sensitive query; and preparing a search results page such that search results more closely matching the derived intended search term are placed in a most prominent position on the search results page.

According to another embodiment of the present disclosure, a computer program product includes a non-transitory computer readable storage medium with computer-executable instructions stored therein. The computer-executable instructions, when executed, cause a computer to perform: receiving a search query with a search term; parsing the search term; determining that at least a portion of the parsed search term is an ambiguous, time-sensitive query; retrieving an intended search term according to a current time of day from a data store when it is determined that at least a portion of the parsed search term is an ambiguous, time-sensitive query; and preparing a search results page such that search results more closely matching the derived intended search term are placed in a most prominent position on the search results page.

### BRIEF DESCRIPTION OF THE SEVERAL VIEWS OF THE DRAWINGS

To describe the foregoing and other exemplary purposes, aspects, and advantages, we use the following detailed description of an exemplary embodiment of the invention with reference to the drawings, in which:

FIG. 1 is a simplified illustration of the process flow for identifying time-sensitive, ambiguous queries, according to an embodiment of the present invention;

FIG. 2 is a high-level flowchart of a method according to an embodiment of the present invention;

FIG. 3 is a flowchart of a method according to an embodiment of the invention;

FIG. 4 is a low-level flowchart of a method according to an embodiment of the present invention;

FIG. 5 is a graph showing results for an ambiguous, time-sensitive query, according to an embodiment of the present invention;

FIG. 6. is a high level block diagram showing an information processing system configured to operate according to an embodiment of the present invention;

FIG. 7 is an illustration of a portion of a search log, according to an embodiment of the present invention;

FIG. 8 shows a portion of a log with search results features, according to an embodiment of the present invention;

FIG. 9 shows a table matching pairs of URLs for distance determination, according to an embodiment of the present invention;

FIG. 10 shows a portion of an exemplary look-up table, according to an embodiment of the present invention;

FIG. 11 shows a partial listing of ambiguous queries matched to intent, according to an embodiment of the present invention;

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

We describe a system and method to detect time sensitive and ambiguous queries in order to optimize search results and advertisements (Ads). We can detect the ambiguous queries and return appropriate related content, shortcuts or Ads to users at the right time. For example, the ambiguous query “Apple” is time sensitive in web search of Taiwan. For the majority of the time, most users issuing the query “Apple” are likely to search for information about Apple Computer such as iPad, iPhone, and Apple Store. However, the ratio of users who search for Apple Daily to those for Apple Computer increases in the morning hours and drops off after noon. (Apple Daily is the best-selling newspaper in Taiwan.) These two intents may be associated with different popular usage times. However, for some ambiguous queries, the distributions of user intents may change over time. A user may query “apple” for “Apple Daily” in the morning, “Apple Stock” in 9:00 am and “Apple Store” in 14:00.

To identify the time sensitive ambiguous queries and their temporal patterns of query intent change is important for effective diversification of search results. We identify the time sensitive ambiguous query and its temporal dynamics from web search logs based on search result click-through behaviors.

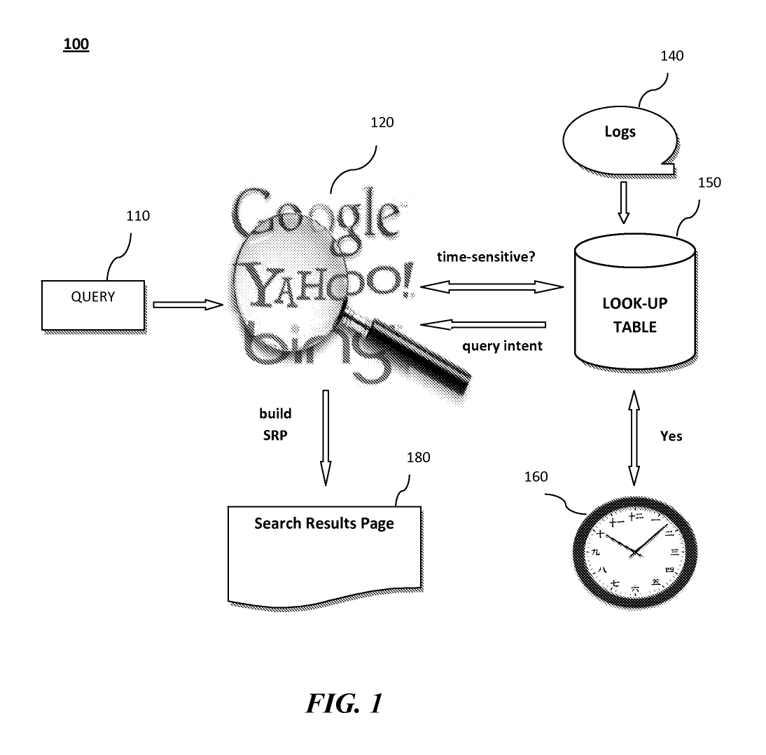

Referring now in specific detail to the drawings, and particularly to FIG. 1, there is provided a simplified illustration of the processing flow for identifying time-sensitive ambiguous queries. The process 100 as illustrated can be thought of as a front-end wrapper to the search process. The processing can be performed by the search engine 120 or by another system that is in operative communication with the search engine 120. For simplicity, we illustrate the process as performed by a search engine 120.

The input to the process 100 is the search query 110 input by a user accessing a search engine 120 through a web browser. The search engine 120 receives the query 110 and parses it in the conventional manner. At this point, front-end processing according to the invention takes over and the query 110 is then applied to a data store 150 such as a look-up table in order to determine if any of the search terms associated with the query 110 is considered time-sensitive. This determination is made when at least one of the search terms matches a time-sensitive query term in the look-up table 150.

The look-up table 150 receives its information from web search logs 140 based on search result click-through behaviors, explained in more detail below. Referring now to FIG. 5 we show a graphical representation of the web search logs 140 of Yahoo! Taiwan from Apr. 22, 2011 to Jul. 22, 2011. Applying an embodiment of the present invention on this historical data, the top ten time-sensitive ambiguous queries were discovered. FIG. 5 shows one such time-sensitive ambiguous query—“Yahoo.” The user intent may be Yahoo! mail (mail.yahoo.com.tw) or Yahoo! News. Applying the method according to the invention, we discover that in the morning hours, more users are likely to search for Yahoo! News; therefore we determine that a query for Yahoo during the morning hours is likely a query for Yahoo! News. In that case, we prepare the SRP 180 so that the search results more closely matching the derived intent (in this case, News) are shown first.

If any of the search terms associated with the query 110 is considered time-sensitive, the process then notes the current time 160 and returns to the look-up table 150 to extract the derived query intent. With this information, the search engine 120 can return more meaningful results by building the search results page (SRP) 180 with the search results listings most closely matching the derived query intent at the top of the page or otherwise feature them more prominently.

Note that if none of the search terms from the query 110 are considered time-sensitive; in other words, no matches were found in the look-up table 150, we can still attempt to determine the user's intent by once again accessing a look-up table 150 such as that shown in FIG. 11 which takes the search logs 140 as input and determines categories for each popular intent (such as News, Sports, Shopping, Blog) associated with the queries associated with the most popular URL. For example, if the user were to input the search query “AppleStore” we look up this term in the look-up table 150 to determine which intent had the most clicks. We see that the Shopping intent had the most clicks, so the Apple shopping URL is the one we would feature most prominently. In the case of the search query “AppleDaily” we see that the News intent is the most popular, so we would feature the news URL more prominently.

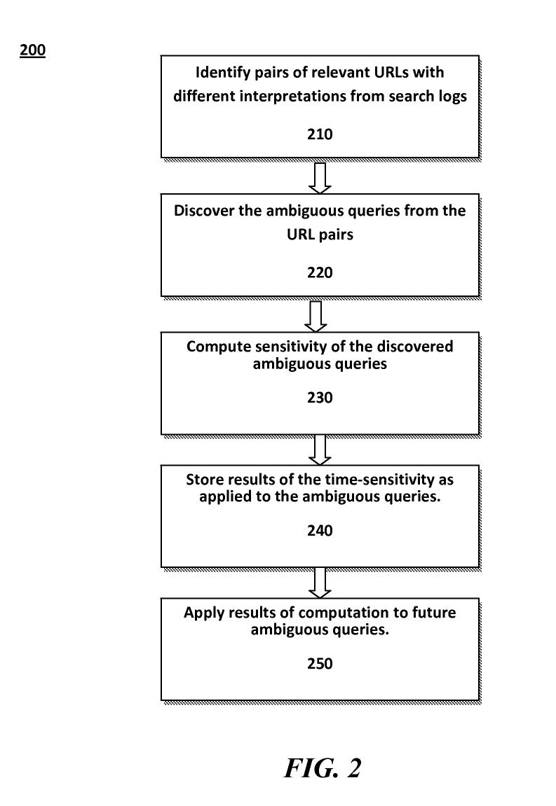

Referring now to FIG. 2 we show a high-level flowchart 200 of a method for optimizing web search results by disambiguating time-sensitive queries. In step 210 we identify relevant query term/URL pairs with different interpretations from search logs 140. See FIG. 7 which shows a portion of a search log. You will note that the query term “yahoo” is somewhat ambiguous in that it was found to be associated with clicks on multiple URLs: www.yahoo.com, mail.yahoo.com, news.yahoo.com, and messenger.yahoo.com.

For example, we identify that given a time granularity ω, popular URLs are extracted first. Popular URLs are those whose click counts under the time interval co are no less than a given threshold α. Then each URL is represented as a bag of query words 115. Instead of using keywords extracted from the web page of the URL, we represent each URL as a bag of query words. The URLs can also be represented by keywords, but this may cause some performance issues.

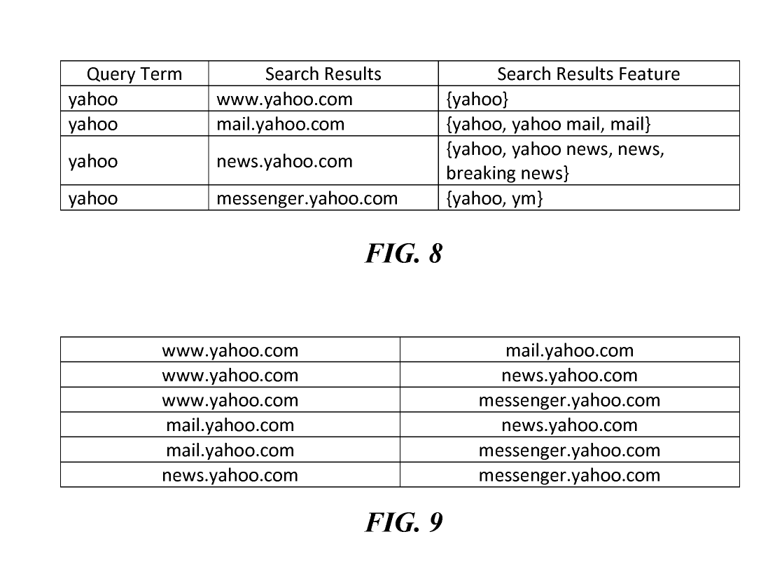

We extract the related query terms from search logs. For example, for the URL “www.apple.com,” our logs indicate a high rate of clicks for this URL when presented as part of a search results listing for the following query terms: “Apple,” “Apple ipad,” “iphone 4s,” “iphone 4s vs samsung.” Therefore, we construct a bag of words for the URL “www.apple.com” with these query terms: {“Apple”, “Apple ipad”, “iphone 4s”, “iphone 4s vs samsung”}. See FIG. 7 showing a partial listing from a search log 140 where query terms are associated with popular URLs. In FIG. 8 the bag of words associated with each URL is added to the search log 140.

In step 220 we discover the ambiguous queries from the pairs of URLs. Therefore, for each popular URL u, those queries whose top-k results contain u are extracted. For example, the popular URL news.yahoo.com from FIG. 9 has associated with it the query terms “news,” “yahoo,” “yahoo news,” and “breaking news.”

Given a pair of URLs with different interpretations, those queries which appear in both URLs are regarded as an ambiguous query. For example, the query “yahoo” is an ambiguous query because it appears in news.yahoo.com, mail.yahoo.com, www.yahoo.com, and messenger.yahoo.com. See FIG. 8. We take the distance between two of these URLs and measure as the Jaccard distance. See FIG. 9. Two URLs are regarded as different interpretations if the Jaccard distance between corresponding query sets is no less than a given threshold β. We compute the distance between the URLs news.yahoo.com and messenger.yahoo.com as follows:

$$1 - \vert \{ yahoo , yahoo news , news , breaking news \} ⋂ \{ yahoo , ym \} \vert / \vert \{ yahoo \} \vert / \vert \{ yahoo , yahoo news , news , breaking news \} ⋃ \{ yahoo , ym \} \vert = 1 - \vert \{ yahoo \} \vert / \vert \{ yahoo , yahoo news , news , breaking news , ym \} \vert = 1 - 1 \text{/} 5$$

Then in step 130 we compute the sensitivity of the discovered ambiguous queries based on a Kullback-Leibler divergence of the distribution of user click-through behaviors. Finally, the time sensitivity of an ambiguous query q is quantified based on symmetrized Kullback-Leibler divergence as follows:

$$δ ( q ) = {max}_{x , y ∈ c ( q )} {D}_{KL} ( {T}_{x}^{q} , {T}_{y}^{q} )$$

where c(q) is the collection of URLs for query q, Tₓ^{q}, T_{y}^{q} is the distribution of URLs x and y for query q respectively. The symmetrized Kullback-Leibler divergence between Tₓ^{q} and T_{y}^{q} is given as follows:

$${D}_{KL} ( {T}_{x}^{q} , {T}_{y}^{q} ) = {\sum }_{i} {T}_{x}^{q} ( i ) log \frac{{T}_{x}^{q} ( i )}{{T}_{y}^{q} ( i )} + {\sum }_{i} {T}_{y}^{q} ( i ) log \frac{{T}_{y}^{q} ( i )}{{T}_{x}^{q} ( i )}$$

where Tₓ^{q}(i) is the percentage of clicks over the i-th time slot among all clicks over the time slots for query q. Once you determine the time sensitivity of an ambiguous query, you get two scores for each pair of URLs, as follows:

| URL1 | URL2 | Jaccard Dist | KLDivergence |
|---|---|---|---|
| google.com | picasweb.google.com | 0.8 | 0.9 |
| news.yahoo.com | yahoo.com | 0.85 | 0.84 |
| apple.com | store.apple.com | 0.2 | 0.3 |

The greater the Jaccard Distance, the more ambiguous the query; the greater the KL Divergence, the more time sensitive the query. We then select the top 500 scores (highest) Jaccard Distance and the top 500 scores (highest) KL Divergence as time-sensitive, ambiguous queries and we focus on those. Or, we can set a threshold for a Jaccard Distance of 0.8 and a KL Divergence of 0.8 and select those queries that are above the threshold.

We store these discovered queries along with their time-sensitive results in step 240 and in step 250 we apply the results of the computation to any future queries that involve the determined ambiguous queries. In this manner we optimize web search results, shortcut clicks, and Ads.

For example, applying the method as shown in FIG. 2 to a query search term “apple” we discover:

1. in the morning, most users that query “apple” are interested in “Apple Daily;” and

2. in the afternoon, most users that query “apple” are interested in “Apple Store.”

Now, applying this discovery, a search engine can optimize search results by making the following changes:

1. move search results featuring “Apple Daily” to a higher (more prominent) position in the morning;

2. move search results featuring “Apple Store” to higher (more prominent) position in the afternoon;

3. feature more “Apple Daily” related shortcuts, e.g. NewsDD, in the morning;

4. feature more “Apple Store” related shortcuts, e.g. ShoppingDD, BlogDD, KnowledgeDD, in the afternoon;

5. feature more “Apple Daily” related Ads in the morning; and

6. feature more “Apple Store” Ads in the afternoon.

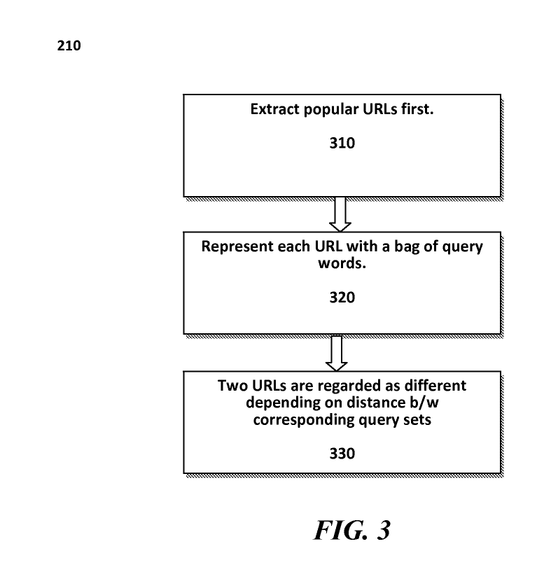

FIG. 3 is a lower-level flowchart detailing the method of step 210 of FIG. 2. In step 310 we extract the popular URLs first. In step 320 we represent each URL as a bag of query words. See FIG. 8. As an example, a bag of query words (related search terms) for “news.yahoo.com” can be {‘yahoo, ‘yahoo news,’ ‘news,’ ‘breaking news’}. Because these query words are related, the user can use ‘breaking news’ as a query term (input to search engine) and be presented with ‘news.yahoo.com’ as a search result. For “mail.yahoo.com” a bag of query words might be {‘yahoo,’ ‘yahoo mail,’ ‘mail’}. So, “news.yahoo.com” can provide such different results from “news.yahoo.com” because the common query term is only ‘yahoo.’ In step 330, for those queries which appear in multiple URLs, we measure the distance between these two URLs as the Jaccard distance. See FIG. 9.

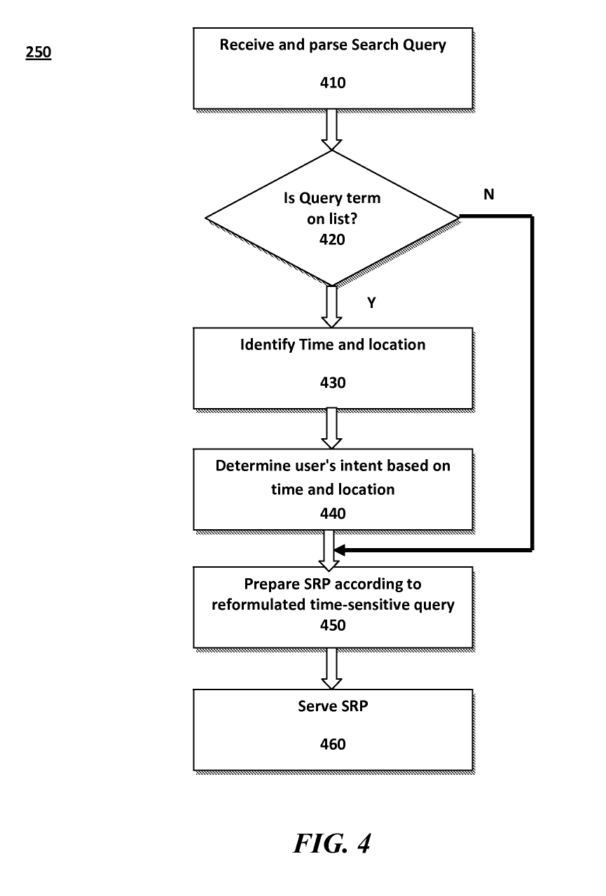

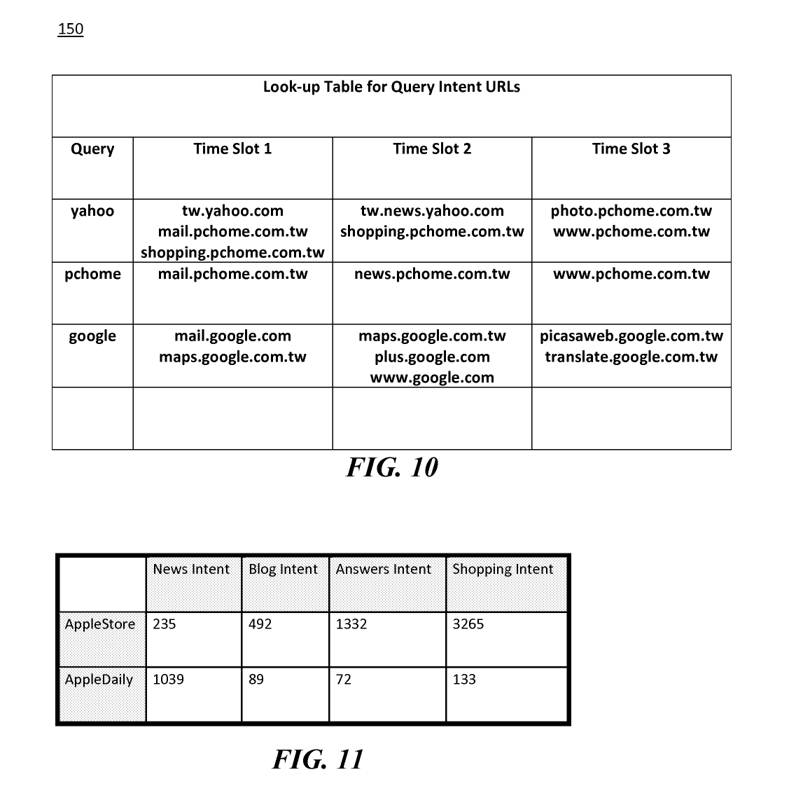

FIG. 4 is a lower-level flowchart detailing step 250 of FIG. 2. First in step 410 the search engine 120 receives and parses a search query 110. In step 420 the search engine 120 analyzes the parsed search query to determine if all or part of the query 110 is a time-sensitive ambiguous query term. This can be done by searching a look-up table 150. If the query term is on the list, this indicates the query term is considered time-sensitive. In that case, we need to identify the current time 160 in step 430. Depending on the time of day (morning, mid-day, evening, work hours, after work hours, weekend), we derive the user's intended result by matching the query term and the time of day 160 with the appropriate intent in step 440. See FIG. 10 we shows a look-up table 140 matching the query intent (URL) with the time of day.

With the information from the look-up table 140 in FIG. 10, we are able to build the SRP 180 to better reflect the user's intention when submitting the query 110. This is accomplished by assembly the search results listing with the derived intended results from the look-up table 140 in a more prominent position on the SRP 180 in step 450. A more prominent position on the SRP 180 can mean that the search results more closely matching the user's intent are placed first. It could also mean that these search results are otherwise featured more prominently, for example, in larger font, bolder font, colors, highlighting, blinking, or other features. Lastly, we serve the SRP 180 in step 460.

Hardware Embodiment.

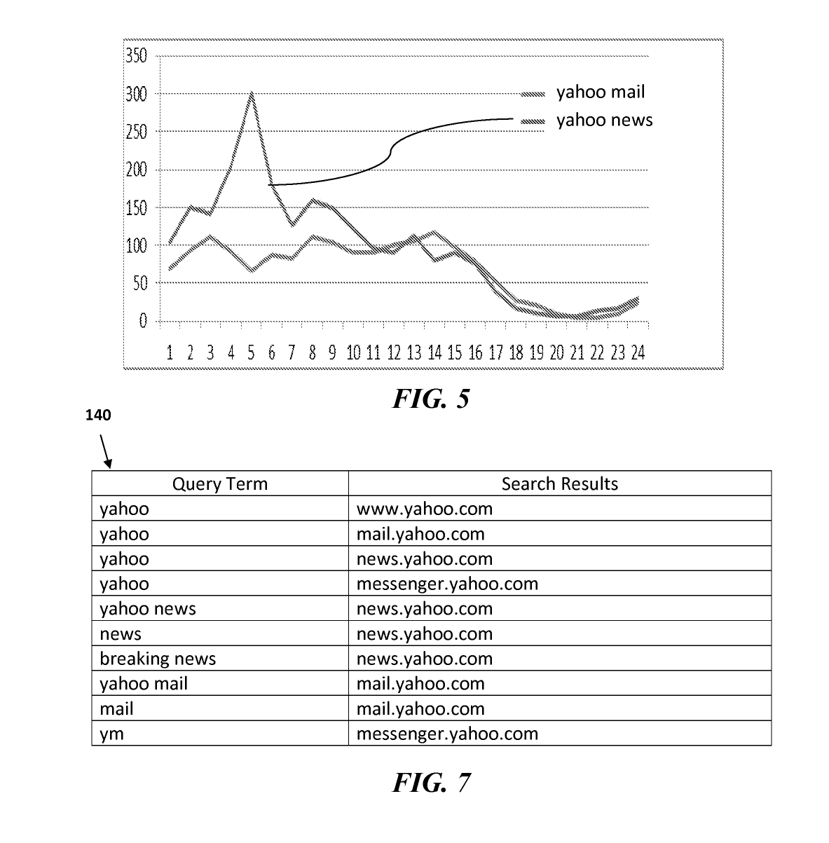

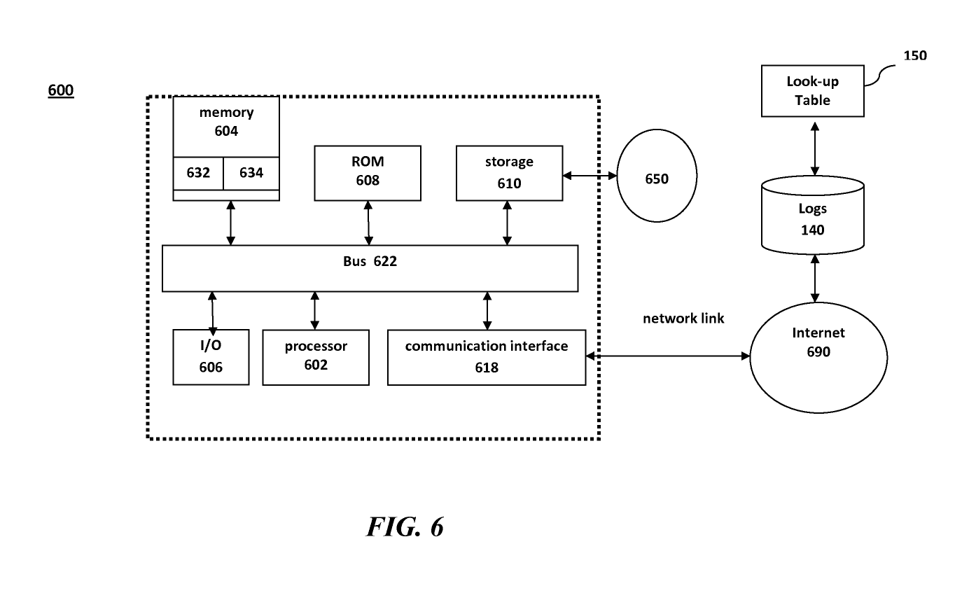

Referring now to FIG. 6, there is provided a simplified pictorial illustration of an information processing system for processing time-sensitive, ambiguous queries in which the present invention may be implemented. For purposes of this invention, computer system 600 may represent any type of computer, information processing system or other programmable electronic device, including a client computer, a server computer, a portable computer, an embedded controller, a personal digital assistant, and so on. The computer system 600 may be a stand-alone device or networked into a larger system. Computer system 600 is illustrated for exemplary purposes as a networked computing device. As will be appreciated by those of ordinary skill in the art, a network may be embodied using conventional networking technologies and may include one or more of the following: local area networks, wide area networks, intranets, public Internet and the like.

In general, the routines which are executed when implementing these embodiments, whether implemented as part of an operating system or a specific application, component, program, object, module or sequence of instructions, will be referred to herein as computer programs, or simply programs. The computer programs typically comprise one or more instructions that are resident at various times in various memory and storage devices in an information processing or handling system such as a computer, and that, when read and executed by one or more processors, cause that system to perform the steps necessary to execute steps or elements embodying the various aspects of the invention.

Throughout the description herein, an embodiment of the invention is illustrated with aspects of the invention embodied solely on computer system 600. As will be appreciated by those of ordinary skill in the art, aspects of the invention may be distributed amongst one or more networked computing devices which interact with computer system 600 via one or more data networks.

Computer system 600 includes processing device 602 which communicates with an input/output subsystem 606, memory 604, storage 610 and network 690. The processor device 602 is operably coupled with a communication infrastructure 622 (e.g., a communications bus, cross-over bar, or network). The processor device 602 may be a general or special purpose microprocessor operating under control of computer program instructions 632 executed from memory 604 on program data 634. The processor 602 may include a number of special purpose sub-processors such as a comparator engine, each sub-processor for executing particular portions of the computer program instructions. Each sub-processor may be a separate circuit able to operate substantially in parallel with the other sub-processors.

Some or all of the sub-processors may be implemented as computer program processes (software) tangibly stored in a memory that perform their respective functions when executed. These may share an instruction processor, such as a general purpose integrated circuit microprocessor, or each sub-processor may have its own processor for executing instructions. Alternatively, some or all of the sub-processors may be implemented in an ASIC. RAM may be embodied in one or more memory chips.

The memory 604 may be partitioned or otherwise mapped to reflect the boundaries of the various memory subcomponents. Memory 604 may include both volatile and persistent memory for the storage of: operational instructions 632 for execution by CPU 602, data registers, application storage and the like. Memory 604 preferably includes a combination of random access memory (RAM), read only memory (ROM) and persistent memory such as that provided by a hard disk drive 608. The computer instructions/applications that are stored in memory 604 are executed by processor 602 for implementing method embodiments of the invention. The computer instructions/applications 632 and program data 634 can also be stored in hard disk drive 608 for execution by processor device 602.

Those skilled in the art will appreciate that the functionality implemented within the blocks illustrated in the diagram may be implemented as separate components or the functionality of several or all of the blocks may be implemented within a single component. The I/O subsystem 606 may comprise various end user interfaces such as a display, a keyboards, and a mouse. The I/O subsystem 606 may further comprise a connection to a network 690 such as a local-area network (LAN) or wide-area network (WAN) such as the Internet.

The computer system 600 may also include a removable storage drive, representing a magnetic tape drive, an optical disk drive, etc. The removable storage drive reads from and/or writes to a removable storage unit 650 in a manner well known to those having ordinary skill in the art. Removable storage unit 650, represents a floppy disk, a compact disc, magnetic tape, optical disk, CD-ROM, DVD-ROM, and the like, which is read by and written to by removable storage drive. As will be appreciated, the removable storage unit 650 includes a non-transitory computer readable medium having stored therein computer software and/or data. The computer system 600 may also include a communications interface 618. Communications interface 618 allows software and data to be transferred between the computer system and external devices.

In this document, the terms “computer program medium,” “computer usable medium,” and “computer readable medium” are used to generally refer to both transitory and non-transitory media such as main memory 604, removable storage drive 650, a hard disk installed in hard disk drive 608, and signals. These computer program products are means for providing software to the computer system 600. The computer readable medium 650 allows the computer system 600 to read data, instructions, messages or message packets, and other computer readable information from the computer readable medium 650.

Therefore, while there has been described what is presently considered to be the preferred embodiment, it will understood by those skilled in the art that other modifications can be made within the spirit of the invention. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the appended claims.

We claim:

1. A method for generating search results, comprising:
using a processor device performing steps of:
receiving a search query comprising a search term;
parsing the search term;
determining that at least a portion of the parsed search term is an ambiguous, time-sensitive query;
retrieving an intended search term according to a current time of day from a data store when it is determined that the at least a portion of the parsed search term is an ambiguous, time-sensitive query; and
preparing a search results page such that search results more closely matching the derived intended search term are placed in a most prominent position on said search results page.

2. The method of claim 1 further comprising serving the search results page.

3. The method of claim 1 wherein the determining comprises:
accessing the data store; and
finding the at least a portion of the parsed search term in the data store.

4. The method of claim 3 wherein accessing the data store comprises accessing a look-up table.

5. The method of claim 3 wherein retrieving the intended search term comprises:
matching the current time of day with an appropriate time of day selection for the search term in the data store; and
selecting the intended search term that matches the appropriate time of day selection.

6. The method of claim 1 further comprising determining that the at least a portion of the parsed search term is location-sensitive.

7. The method of claim 1 wherein placing the search results in the most prominent position on the search results page comprises placing said search results at a beginning of a listing.

8. The method of claim 3 further comprising:
identifying ambiguous, time-sensitive queries and their temporal dependencies from web search logs based on search result click-through behaviors.

9. The method of claim 8 further comprising:
determining a Jaccard Distance score and a Kullback-Leibler divergence score for pairs of URLs to identify the ambiguous, time-sensitive queries.

10. An information processing system for generating search results, said information processing system comprising:
a memory with computer-executable instructions stored therein, said computer-executable instructions comprising:
receiving a search query comprising a search term;
parsing the search term;
determining that at least a portion of the parsed search term is an ambiguous, time-sensitive query;
retrieving an intended search term according to a current time of day from a data store when it is determined that the at least a portion of the parsed search term is an ambiguous, time-sensitive query; and
preparing a search results page such that search results more closely matching the derived intended search term are placed in a most prominent position on said search results page; and
a processor device operably coupled with the memory and executing the computer-executable instructions.

11. The information processing system of claim 10 wherein the computer-executable instructions further comprise serving the search results page.

12. The information processing system of claim 10 wherein the computer-executable instructions for determining that at least a portion of the parsed search term is an ambiguous, time-sensitive query comprises:
accessing the data store; and
finding the at least a portion of the parsed search term in the data store.

13. The information processing system of claim 12 wherein accessing the data store comprises accessing a look-up table.

14. The information processing system of claim 12 wherein retrieving the intended search term comprises:
matching the current time of day with an appropriate time of day selection for the search term in the data store; and
selecting the intended search term that matches the appropriate time of day selection.

15. The information processing system of claim 10 further comprising determining that the at least a portion of the parsed search term is location-sensitive.

16. The information processing system of claim 10 wherein placing the search results in the most prominent position on the search results page comprises placing said search results at a beginning of a listing.

17. The information processing system of claim 13 further comprising:
identifying ambiguous, time-sensitive queries and their temporal dependencies from web search logs based on search result click-through behaviors.

18. The information processing system of claim 17 further comprising:
determining a Jaccard Distance score and a Kullback-Leibler divergence score for pairs of URLs to identify the ambiguous, time-sensitive queries.

19. A computer program product comprising a non-transitory computer readable storage medium with computer-executable instructions stored therein, said computer-executable instructions comprising:
receiving a search query comprising a search term;
parsing the search term;
determining that at least a portion of the parsed search term is an ambiguous, time-sensitive query;
retrieving an intended search term according to a current time of day from a data store when it is determined that the at least a portion of the parsed search term is an ambiguous, time-sensitive query; and
preparing a search results page such that search results more closely matching the derived intended search term are placed in a most prominent position on said search results page.

20. The computer program product of claim 19 wherein the computer-executable instructions further comprise:
determining a Jaccard Distance score and a Kullback-Leibler divergence score for pairs of URLs to identify the ambiguous, time-sensitive queries.
